(19) United States
(12) Patent Application Publication
(10) Pub. No.: US 2019/0249024 A1
(43) Pub. Date: Aug. 15, 2019

(54) INK SET FOR INKJET PRINTING

(71) Applicant: MIMAKI ENGINEERING CO., LTD., Nagano (JP)

(72) Inventors: Masanobu Shinohara, Nagano (JP); Hiromi Miyakoshi, Nagano (JP)

(73) Assignee: MIMAKI ENGINEERING CO., LTD., Nagano (JP)

(21) Appl. No.: 16/254,622

(22) Filed: Jan. 23, 2019

(30) Foreign Application Priority Data
Feb. 9, 2018 (JP) 2018-021489

(51) Int. Cl. C09D 11/40; B41M 5/00; C09D 11/102; C09D 11/106

(52) U.S. Cl. CPC C09D 11/40; C09D 11/106; C09D 11/102; B41M 5/0023

(57) ABSTRACT

Provided are an ink set for inkjet printing that achieves remarkable adhesion to plastic base materials and provides a print result improved in water resistance and alcohol resistance, an inkjet printing method, and an inkjet printing apparatus. The inkjet printing method includes a first ink applying step of applying a first ink to a print medium, the first ink containing an epoxy compound and at least one anionic component, and a second ink applying step of applying a cationic second ink to the print medium, the second ink containing an amine-based polymer in which at least one of polyethylene hydrogens is substituted with a —CH₂NH₂ group.

### CROSS REFERENCE TO RELATED APPLICATIONS

This application claims the priority benefit of Japanese Patent Application No. 2018-021489, filed on Feb. 9, 2018. The entirety of the above-mentioned patent application is hereby incorporated by reference herein and made a part of this specification.

### TECHNICAL FIELD

This disclosure relates to an ink set for inkjet printing.

### DESCRIPTION OF THE BACKGROUND ART

An inkjet printing carries out a printing operation by ejecting and adhering fine droplets of ink to a surface of a print medium. In the inkjet printing, therefore, inks that can be well-adhered to print mediums should importantly be used. Other factors required of the inkjet printing may include good water resistance and alcohol resistance.

JP H05-027551 B describes an inkjet recording method for adhering a recording liquid, for example, ink, to a recording medium. In this method, a recording medium is used that includes a base material and a coating layer formed on the base material, one of the base material and the coating layer is impregnated with polyallylamine salt, and the liquid used for recording is an aqueous recording liquid with water content of 20% to 90%. The method described in this literature may achieve improved water resistance and light resistance.

Specifically, polyallylamine salt is used as an optimizer that serves to prevent smearing of a print result. Polyallylamine salt is applied to and dried on the base material to produce the recording medium, as in the following steps, 1) a polyallylamine salt-containing aqueous solution is used to prepare the base material, 2) the base material is then impregnated with a polyarylamine salt-added impregnating solution for post-treatment.

JP H11-34478 A describes an inkjet recording method in which a reaction liquid and an ink composition are adhered to a print medium. The reaction liquid at least contains a multivalent metal salt or polyallylamine or a derivative thereof. An ink composition at least contains a colorant, fine particles of a self-crosslinking polymer having film forming properties, an inorganic colloid oxide, an aqueous organic solvent, and water. The polymer has a core-shell structure consisting of a shell layer with a carboxy group and a core layer with an epoxy group. This recording method may obtain a print result that excels in scratch resistance using plain paper without risks of ink bleeding, color mixing, or printing unevenness.

In the recording method described in JP H05-027551 B, however, salt contained in polyallylamine salt may lead the following adverse events; poor adhesion to plastic base materials such as polypropylene (hereinafter, PP) and polyester (hereinafter, PEs), greater risk of hydrolysis in the presence of salt, and poor water resistance.

Polyallylamine salt mixed with ink droplets of coloring ink that landed on the recording medium may serve as an optimizer. Polyallylamine salt being mixed with ink droplets specifically means that polyallylamine salt applied to and dried on the base material redissolves into the ink droplets, that is to say, poor water resistance. Thus, the recording method described in JP H05-027551 B may be inherently unable to obtain a print result that excels in water resistance.

In the recording method described in JP H11-34478 A, the ink composition containing the self-crosslinking polymer including epoxy and carboxyl groups may involve a high risk of poor ink ejection because the ink, if dried near an ejection nozzle, is likely to form a rigid crosslinked structure, clogging the nozzle.

### SUMMARY

Various studies and discussions led to the findings below.

This disclosure is characterized by using two different inks, which are a first ink containing an epoxy compound and at least one anionic component, and a second ink containing an amine-based polymer in which at least one of polyethylene hydrogens is substituted with a —CH₂NH₂ group. The second ink reacts with the anionic component of the first ink and may thereby prevent diffusion of a colorant on a print medium so as to suppress risks of smearing and printing unevenness.

1) An ink set for inkjet printing is provided that includes a first ink containing an epoxy compound and at least one of an anionic colorant, an anionic dispersing agent, and an anionic binder, and a second ink containing an amine-based polymer in which at least one of polyethylene hydrogens is substituted with a —CH₂NH₂ group.

In the ink set according to the aspect 1), of the constituents of the first ink, at least one of the colorant, dispersing agent, and binder that fixes the colorant to a print medium includes an anionic component. Therefore, the cationic amine-based polymer of the second ink and the anionic component react with each other and provide an anti-smearing effect.

2) The ink set for inkjet printing according to the aspect 1) may be further characterized in that the first ink and the second ink are applied in undried state and in contact with each other.

To optimize the anti-smearing effect, redissolution and resulting reaction should desirably start as soon as one of the inks is applied although the other ink may be dry. In the epoxy reaction, however, a water-resistant film may be difficult to form unless the inks are both in liquid state. In the ink set according to the aspect 2), the undried first and second inks allowed to contact each other may facilitate the formation of a film that excels in water resistance.

3) The ink set for inkjet printing according to the aspect 1) or 2) may be further characterized in that the amine-based polymer has an average molecular weight greater than or equal to 5,000 and less than or equal to 20,000.

The ink set according to the aspect 3) may provide ink having remarkable solubility and low viscosity that can be easily ejected through a nozzle.

4) The ink set for inkjet printing according to one of the aspects 1) to 3) may be further characterized in that the amine-based polymer is polyallylamine.

Polyallylamine is highly reactive and is likely to form a three-dimensional network through, particularly, a reaction with an epoxy or a urethane group. In the ink set according to the aspect 4), increased adhesion and improved water and alcohol resistances may be obtained with print mediums made of synthetic resins.

Conventionally, polypropylene (PP) and polyester (PEs) used for print medium are subjected to corona treatment. Electrostatic interaction or chemical reaction between amine and functional groups generated by the corona treatment may favorably improve adhesion between the inks and print mediums.

5) The ink set for inkjet printing according to one of the aspects 1) to 4) may be further characterized in that a quantity of the amine-based polymer is greater than or equal to 1 wt. % and less than or equal to 10 wt. % to a total quantity of the second ink.

In case the amount of the amine-based polymer included in the second ink is too small, adhesion to the print medium may be degraded. On the other hand, the amine-based polymer in excess may result in ejection failure. The ink set according to the aspect 5) may provide ink having remarkable adhesion to print mediums and easy to eject through a nozzle.

6) The ink set for inkjet printing according to one of the aspects 1) to 5) may be further characterized in that the epoxy compound is a multifunctional epoxy resin.

In the ink set according to the aspect 6) in which the second ink contains a highly reactive multifunctional epoxy resin, the amine-based polymers of the respective inks that are crosslinked with each other form a polymer ink that excels in water resistance and chemical resistance and having a rigid three-dimensionally crosslinked structure.

The ink set for inkjet printing characterized as described in the aspects 1) to 6) may achieve remarkable adhesion to print mediums, particularly to plastic materials such as PP and PEs, and provide a print result improved in water resistance and alcohol resistance.

### BRIEF DESCRIPTION OF THE DRAWINGS

FIG. 1 is an upper view of an inkjet printing apparatus using an inkjet printing method according to a second embodiment of this disclosure.

### DETAILED DESCRIPTION OF EMBODIMENTS

To address the issue of the known art, this disclosure provides an ink set for inkjet printing that may enable excellent adhesion to plastic base materials, water resistance, and alcohol resistance.

Embodiments of this disclosure are hereinafter described in detail. This disclosure is not necessarily limited to the embodiments and may be variously modified within the scope and spirit of this disclosure. In this specification, “A-B” used to express any numerical range means “greater than or equal to A and less than or equal to B”, unless specified otherwise.

The description starts with an ink set for inkjet printing according to a first embodiment of this disclosure. An ink set for inkjet printing according to the first embodiment includes a first ink containing an epoxy compound and at least one of an anionic colorant, an anionic dispersing agent, and an anionic binder, and a second ink containing an amine-based polymer in which at least one of polyethylene hydrogens is substituted with a —CH₂NH₂ group.

First Ink

The first ink according to an aspect contains an epoxy compound, specifically, a multifunctional epoxy resin.

Epoxy Compound

Examples of the epoxy compound may include polyethylene glycol diglycidyl ether, diglycerol polyglycidyl ether, and sorbitol polyglycidyl ether. More specific examples may include Denacol EX-821, Denacol EX-841, Denacol EX-421, Denacol EX-614B (all supplied by Nagase ChemteX Corporation).

Instead of the epoxy compound, the first ink may contain a urethane resin having an urethane group.

Other Constituents

The first ink contains, in addition to the epoxy compound, a colorant, a dispersing agent, a surfactant, an acrylic resin emulsion, alcohol, and water. Examples of these additional constituents may include, colorant: HiBlack 890 (supplied by Orion Engineered Carbons), dispersing agent: BYKJET 9151 (supplied by BYK Japan KK), and surfactant: BYK-349 (supplied by BYK Japan KK). An example of the acrylic resin emulsion is Mowinyl 6899D (supplied by The Nippon Synthetic Chemical Industry Co., Ltd.).

Second Ink

The second ink according to an aspect contains an amine-based polymer in which at least one of polyethylene hydrogens is substituted with a —CH₂NH₂ group.

Amine-Based Polymer

An example of the amine-based polymer is polyallylamine in which allylamine is polymerized. A quantity of the amine-based polymer may desirably be greater than or equal to 1 wt. % and less than or equal to 10 wt. % to a total quantity of the second ink. Specific examples of polyallylamine may include PAA-15C and PAA-08 (both supplied by NITTOBO MEDICAL CO., LTD.). Polyallylamine is expressed by the structural formula (1)).

An average molecular weight of the amine-based polymer, though not particularly limited, may be greater than or equal to 1,000 and less than or equal to 50,000, desirably be greater than or equal to 3,000 and less than or equal to 30,000, or more desirably be greater than or equal to 5,000 and less than or equal to 20,000. For example, an average molecular weight of PAA-15C is 15,000, and an average molecular weight of PAA-08 is 8,000.

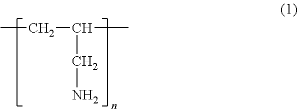

In the structural formula (1), n may be an integral number greater than or equal to 15.

In the amine-based polymer, polyethylene hydrogens may be further substituted in part with any a substituent group but —CH₂NH₂ group to an extent that does not compromise effects described herein.

### Working Example 1

This disclosure is hereinafter described based on working examples, but is not particularly limited thereto.

### Preparation of First Ink and Second Ink

### Working Example 1

First Ink

The following materials were mixed to prepare the first ink; 3 wt. % of HiBlack 890 (Orion Engineered Carbons), 1.2 wt. % of BYKJET 9151 (BYK Japan KK), 0.2 wt. % of 1,2-hexanediol, 20 wt. % of propylene glycol, 0.5 wt. % of BYK-349 (BYK Japan KK), 21.4 wt. % of Mowinyl 6899D (Japan Coating Resin co., ltd., concentration of 42 wt. %), 1.5 wt. % of Denacol EX-821 (Nagase ChemteX Corporation), and 52.2 wt. % of water.

Second Ink

The following materials were mixed to prepare the second ink; 20 wt. % of PAA-15C (NITTOBO MEDICAL CO., LTD, concentration of 15 wt. %), 2 wt. % of 1,2-hexanediol, 0.5 wt. % of 1,2-octanediol, 2 wt. % of 3-methoxy-3-methyl-butanol, and 75.5 wt. % of water.

### Working Examples 2 to 4, Comparative Examples 1 and 2

First and second inks were prepared according to the same method as in the working example 1, except that compositions of the inks were changed as shown in Table 1.

TABLE 1
All of values in the unit of wt. %

| | | | | | |
|---|---|---|---|---|---|
| Working | Working | Working | Working | Comparative | Comparative |
| example 1 | example 2 | example 3 | example 4 | example 1 | example 2 |

Coloring ink (first ink)

| | | | | | | |
|---|---|---|---|---|---|---|
| HiBlack890 | 3 | 3 | 3 | 3 | 3 | 3 |
| BYKJET9151 | 1.2 | 1.2 | 1.2 | 1.2 | 1.2 | 1.2 |
| 1,2-hexanediol | 0.2 | 0.2 | 0.2 | 0.2 | 0.2 | 0.2 |
| Propylene glycol | 20 | 20 | 20 | 20 | 20 | 20 |
| BYK-349 | 0.5 | 0.5 | 0.5 | 0.5 | 0.5 | 0.5 |
| Mowinyl 6899D (concentration: | 21.4 | 21.4 | 21.4 | 21.4 | 21.4 | 21.4 |
| 42 wt. %) | | | | | | |
| Denacol EX-821 | 1.5 | | | | | |
| Denacol EX-841 | | 3 | | | | |
| Denacol EX-421 | | | 1.3 | | | |
| Denacol EX-614B | | | | 1.4 | | 1.4 |
| Water | 52.2 | 50.7 | 52.4 | 52.3 | 53.7 | 52.3 |

Coherent ink (second ink)

| | | | | | | |
|---|---|---|---|---|---|---|
| PAA-15C (concentration: 15 wt. | 20 | 20 | | | | |
| %) | | | | | | |
| PAA-08 (concentration: 15 wt. | | | 46.7 | 46.7 | 46.7 | |
| %) | | | | | | |
| 1,2-hexanediol | 2 | 2 | 2 | 2 | 2 | |
| 1,2-octanediol | 0.5 | 0.5 | 0.5 | 0.5 | 0.5 | |
| 3-methoxy-3-methyl-1-butanol | 2 | 2 | 2 | 2 | 2 | |
| Water | 75.5 | 75.5 | 48.8 | 48.8 | 48.8 | |
| Adhesion to PP | 10 | 10 | 10 | 10 | 10 | 0 |
| Adhesion to PET | 10 | 10 | 10 | 10 | 10 | 0 |
| Water resistance | 10 | 10 | 10 | 10 | 4 | 2 |
| Ethanol resistance | 60% | 40% | 40% | 50% | <10% | <10% |

Printing

A printer JV400-160LX (supplied by MIMAKI ENGINEERING CO., LTD.) was filled with the first ink and the second ink and was used to carry out a printing operation using mediums made of PP (FOS-BT, supplied by FUTAMURA CHEMICAL CO.,LTD.) and PEs (Lumirror S10, supplied by TORAY INDUSTRIES INC. and HK-31WF, supplied by Higashiyama Film Co., Ltd.). In the printing operation, a concentration of the first ink was set to 100%, and a concentration of the second ink was set to 40%, and steps of applying the first ink and the second ink were performed substantially at the same time.

Evaluation of Adhesion to PP

A coating layer formed of the first and second inkjet inks on the PP medium was cut in a shape of X by a cutter. A 18 mm-square piece of a cellophane adhesive tape (CT405AP-18, supplied by Nichiban Co., Ltd.) was bonded to a X-shaped cut part and then swiftly peeled off in a direction at an angle of approximately 60° from a medium surface. Any portion of the coating layer left unpeeled was visually checked and evaluated on a scale of 0 to 10 to see how adherable the inks were to the PP medium. In the evaluation of gained scores, a score “X” (X is an integral number from 0 to 10) indicates that an “X” ratio of the coating layer was not peeled off. For example, score “3” indicates that “3” out of “10” (i.e., 30% of the whole coating layer) was not peeled off.

Evaluation of Adhesion to PEs

The adhesion of the inks to PEs was evaluated in the same manner as the adhesion to PP, except that the medium used was PEs (Lumirror S10).

Water Resistance

The coating layer formed of the first and second inkjet inks on the PEs medium (HK-31WF) was repeatedly rubbed back and forth under a load of 200 gf with a cotton swab impregnated with water. The coating layer was repeatedly rubbed 10 times at most to record how many times the coating layer was rubbed before peeling off.

Ethanol Resistance

The coating layer formed of the first and second inkjet inks on the PEs medium (HK-31WF) was repeatedly rubbed back and forth under a load of 200 gf with a cotton swab impregnated with ethanol (concentrations of 10% to 100%, with 10% increments). The coating layer was repeatedly rubbed 10 times at most to record a highest ethanol concentration at which the coating layer was not peeled off.

The ink set for inkjet printing according to the first embodiment may provide a coating layer improved in water resistance through a reaction among the cationic amine-based polymer of the second ink, and the epoxy compound, and the anionic colorant, dispersing agent, or binder of the first ink.

The ink set for inkjet printing according to the first embodiment may provide a coating layer improved in smearing resistance through a reaction between the anionic component of the first ink and the cationic amine-based polymer of the second ink.

In the ink set for inkjet printing according to the first embodiment, of the constituents of the first ink, at least one of the colorant and the binder that fixes the colorant to a print medium includes an anionic component. Therefore, the anionic component and the cationic amine-based polymer of the second ink reacting with each other may provide an anti-smearing effect.

When the colorant is a pigment, a dispersing agent may be necessarily used in order to allow vivid coloring by preventing particles of the pigment from agglomerating with one another. In the ink set for inkjet printing according to the first embodiment, of the constituents of the first ink, at least one of the colorant which may be a pigment, a dispersing agent, and a binder that fixes the colorant to a print medium includes an anionic component. Therefore, the anionic component and the cationic amine-based polymer of the second ink reacting with each other may provide an anti-smearing effect.

In the ink set for inkjet printing according to the first embodiment, the first ink easier to dissolve and reduced in viscosity may be easily and smoothly ejected through a nozzle.

Polyallylamine is highly reactive and is likely to form a three-dimensional network through, particularly, a reaction with an epoxy or a urethane group. In the ink set for inkjet printing according to the first embodiment, increased adhesion and improved water and alcohol resistances may be obtained with print mediums made of synthetic resins.

Conventionally, polypropylene (PP) and polyester (PEs) used for print medium are subjected to corona treatment. Electrostatic interaction or chemical reaction between amine and functional groups generated by the corona treatment may favorably improve adhesion between the inks and print mediums.

In case the amount of the amine-based polymer included in the second ink is too small, adhesion to the print medium may be degraded. On the other hand, the amine-based polymer in excess may result in ejection failure. The ink set for inkjet printing according to the first embodiment may provide ink that can be well-adhered to print mediums and easily ejected through a nozzle.

An inkjet printing method according to a second embodiment of this disclosure is hereinafter described. In this disclosure, an inkjet printing apparatus using print mediums is equipped with the ink set for inkjet printing according to the first embodiment.

The inkjet printing apparatus, which is configured similarly to apparatuses of the known art, is not described herein in detail.

This inkjet printing method includes: a first ink applying step of applying a first ink to a print medium, the first ink containing an epoxy compound and at least one anionic component; and a second ink applying step of applying a cationic second ink to the print medium, the second ink containing an amine-based polymer in which at least one of polyethylene hydrogens is substituted with a —CH₂NH₂ group.

The second ink applying step may desirably be performed substantially at the same time as the first ink applying step.

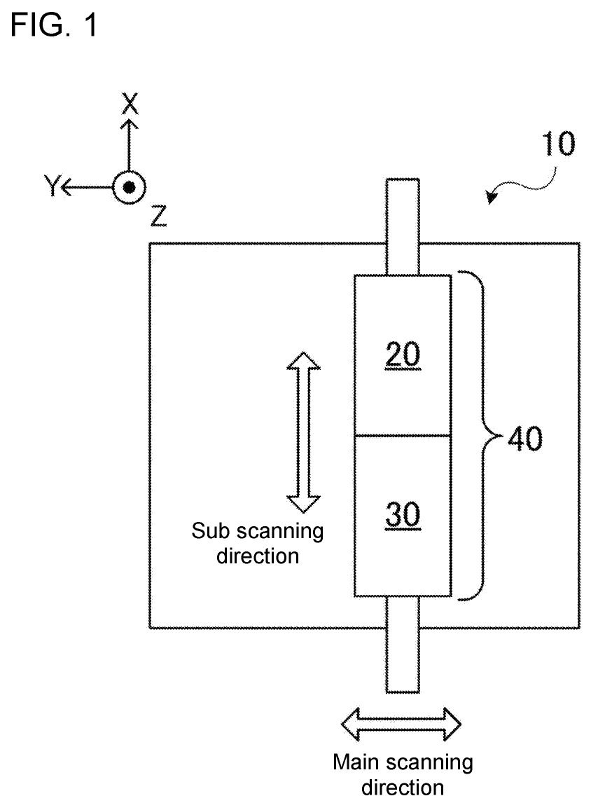

“The second ink applying step being performed substantially at the same time as the first ink applying step” specifically means ejecting droplets of the first and second inks so as to land on the print medium substantially at the same time. To allow droplets of the first and second inks to land on the print medium substantially at the same time, an inkjet printing apparatus 10 may be used that includes a first ink ejection unit 20 and a second ink ejection unit 30 that are respectively for ejection of the first and second inks and arranged in-line with each other along a sub scanning direction (X-axis direction) of a inkjet head 40 as illustrated in FIG. 1.

An unpaired electron of nitrogen N in an amine launches a nucleophilic attack against a carbon C of an epoxide ring, upon which the ring opens and the amine is added, and a secondary amine then reacts with another epoxide. Through such a chained polymerization, the amine and the epoxy group form a three-dimensionally crosslinked structure. The inkjet printing method according to the second embodiment may provide a print result well-adhered particularly to PP or PEs plastic mediums and improved in water resistance and alcohol resistance.

The inkjet printing method according to the second embodiment, by performing the second ink applying step substantially at the same time as the first ink applying step, may provide a print result well-adhered to a print medium and improved in water resistance and alcohol resistance.

The inkjet printing method described above may be rephrased as a manufacturing method for an inkjet printed matter.

The ink set for inkjet printing and the inkjet printing method described herein are not limited to the embodiments and may be variously modified within the scope and spirit of this disclosure.

In the ink set for inkjet printing according to the first embodiment, the colorant is included in the first ink, but may be added to the second ink. In this instance, the colorant may include a cationic component.

When the first ink and the second ink are applied, one of these inks containing no colorant is first applied to a print medium, and the other colorant-containing color ink is then spread on the colorless ink applied earlier

The colorant may be a dye other than a pigment, in which case the first ink may need no dispersing agent.

Various embodiments and modifications are possible without departing from the broader spirit and scope of the present disclosure. In addition, the above-described embodiments are only for describing the present disclosure and do not limit the scope of the present disclosure. Namely, the scope of the present disclosure is determined not due to the embodiments but due to the claims. Various modifications that are made within the scope of the claims and within the meaning of the disclosure equivalent thereto are considered to be within the scope of the present disclosure.

What is claimed is:

1. An ink set for inkjet printing, comprising:
a first ink including an epoxy compound and at least one of an anionic colorant, an anionic dispersing agent, and an anionic binder; and
a second ink including an amine-based polymer in which at least one of polyethylene hydrogens is substituted with a —CH₂NH₂ group.

2. The ink set for inkjet printing according to claim 1, wherein the first ink and the second ink are applied in undried state and in contact with each other.

3. The ink set for inkjet printing according to claim 1, wherein the amine-based polymer has an average molecular weight greater than or equal to 5,000 and less than or equal to 20,000.

4. The ink set for inkjet printing according to claim 1, wherein the amine-based polymer is polyallylamine.

5. The ink set for inkjet printing according to claim 1, wherein a quantity of the amine-based polymer is greater than or equal to 1 wt. % and less than or equal to 10 wt. % to a total quantity of the second ink.

6. The ink set for inkjet printing according to claim 1, wherein the epoxy compound is a multifunctional epoxy resin.
